(19) United States
(12) Patent Application Publication
(10) Pub. No.: US 2026/0369461 A1
(43) Pub. Date: Nov. 19, 2026

(54) INDUCTIVE COMPONENT, MOLD TOOL AND METHOD OF EMBEDDING

(71) Applicant: TDK Electronics AG, Muenchen (DE)

(72) Inventors: Fabian Beck, Rüttenen (CH); Beate Walter, Herbrechtingen (DE); Patrick Keck, Herbrechtingen (DE); Dirk Beckmann, Königsbronn (DE); Michael Heriadin, Nördlingen (DE)

(21) Appl. No.: 19/141,265

(22) PCT Filed: Dec. 19, 2023
(86) PCT No.: PCT/EP2023/086526

§ 371 Date: Jun. 19, 2025

(30) Foreign Application Priority Data
Dec. 28, 2022 (DE) 10 2022 134 934.9

(51) Int. Cl. H01F 27/29; H01F 17/02; H01F 27/32; H01F 41/12

(52) U.S. Cl. CPC H01F 27/292; H01F 17/02; H01F 27/327; H01F 41/127

(57) ABSTRACT

In an embodiment an inductive component includes an electrical conductor with a first terminal, a second terminal and a central region, which is electrically arranged between the first terminal and the second terminal, and a body comprising a central area, wherein the central area is centered in the body, and wherein the body has one or more first, outwardly open recess(es).

### CROSS-REFERENCE TO RELATED APPLICATIONS

This patent application is a national phase filing under section 371 of PCT/EP2023/086526, filed Dec. 19, 2023, which claims the priority of German patent application no. 102022134934.9, filed Dec. 28, 2022, each of which is incorporated herein by reference in its entirety.

### TECHNICAL FIELD

The invention relates to inductive components, in particular inductive components with improved magnetic properties, mold tools for manufacturing such components and methods for embedding, e.g. for embedding electrical conductors in a component body.

### BACKGROUND

Inductive components can be used in electrical circuits where they realize inductive circuit elements. The inductances of such components are generally characterized by the shape of an electrical conductor and the magnetic properties of its environment. For example, a coil can be encapsulated in a surrounding material. The position of the coil in the encapsulation material influences the magnetic and electrical properties of the corresponding component.

For example, inductive elements with a holder for the coil are known from the publications U.S. Pat. Nos. 9,728,331 B2, 4,801,912 A or US 2010/0219924 A1. Complex process steps for manufacturing inductive components are known from US 2012/0019343 A1 or US 2009/0250836 A1.

However, there is still a desire for inductive components that can be produced using simple, easy-to-perform manufacturing steps and have precisely adjustable magnetic properties.

### SUMMARY

Embodiments provide an inductive component in which contact connections for interconnection with an external circuit environment are exactly localized and precisely aligned.

The inductive component comprises an electrical conductor. The electrical conductor has a first terminal and a second terminal. Furthermore, the electrical conductor has a central area. The central area is electrically arranged between the first terminal and the second terminal. Furthermore, the inductive component has a body in which the central area is arranged. The central area is centered in the body. Furthermore, the body has a first, outwardly open recess.

The electrical arrangement of the central area between the first terminal and the second terminal essentially means that the electrical conductor is designed in such a way that the central area of the electrical conductor is connected in series between the first terminal and the second terminal. The centering of the central area in the body means that the procession of the central area in the body is fixed with high precision. As a result, the magnetic environment of the central area of the electrical conductor is essentially defined with high precision, so that the electrical and magnetic properties of the inductive element can be set with high precision.

The presence of the outwardly open recess is directly related to the inductance being adjustable with high precision. The outwardly open recess serves to hold the electrical conductor, and particularly its central area, in the intended position during the manufacturing process of the inductive component. Mold materials can then be used to surround the central area, ensuring that the central area is securely fixed even at high mold pressures. The position within the body and thus the thicknesses of the material of the body in the various directions around the central area are thus firmly defined, resulting in the high precision of the adjustability of the electrical magnetic properties of the inductive component.

The central area of the electrical conductor is essentially the area of the conductor that largely determines the electrical or magnetic properties of the inductive component.

It is possible for one or more recesses to form an angle β of 0°≤B≤20° with the respective side surface. The respective side surface is the side surface that contains the respective recess. The presence of an angle >0° means that the recess, especially its side surface, is inclined to the side. This makes it possible—especially if two recesses are arranged opposite each other—to fix the central area and even press it downwards so that one side of a terminal is optimally aligned for subsequent soldering and the central area is aligned relative to the material of the body. An associated mold tool can have a V-shaped area for this purpose, in which the opening of the area points downwards. This means that the opening of the “V” points downwards.

It is possible that the electrical conductor in the central area is formed into one or more coils. The electrical conductor can consist of one or more wires or comprise a wire whose corresponding section is formed into windings that form the coil(s) of the inductive component.

The first terminal and the second terminal of the electrical conductor represent terminal options of the inductive component, with which the inductive component can be connected to an external circuit environment. The first terminal and the second terminal can protrude from the body of the inductive component on different sides of the inductive component. However, it is also possible for both terminals to protrude on the same side of the body. This is particularly advantageous if the inductive component is to be connectable to a printed circuit board using SMD technology (SMD=surface mounted device).

The coil can have essentially circular windings. In particular, the coil can be a cylindrical coil or a planar coil. However, it is also possible for the windings of the coil to have an oval cross-section or a rectangular cross-section.

It is possible that the body of the inductive component, in which the central area is located, contains a mold material or consists of a mold material.

It is also possible for the central area of the electrical conductor to be embedded in the body of the inductive component.

Embedding by means of molding (casting) is an easy way to produce an inductive component. It is possible for the central area and the mold material surrounding the central area to form a monolithic inductive component. The central area of the electrical conductor is essentially in direct contact with the mold material over its entire length.

It is possible that the body contains a second, outwardly open recess, which is arranged opposite the first recess on the body in such a way that the central area is arranged between the first and second recesses.

The significance of the recesses is that during manufacture the associated mold tool has correspondingly shaped elements, e.g. ribs or lamella, which hold the central area of the inductive component in position during molding. Ribs of the mold tool can press against the central area of the electrical conductor from different directions, e.g. from opposite directions, and thus hold it in a fixed position with high precision, even if during molding, i.e. during casting with the casting compound, a high mold pressure, depending on the mold material, is required for casting.

In particular, the mold tool has a cavity which is intended to be filled by the mold material, wherein the filling of the cavity by the mold material forms the subsequent body in which the electrical conductor with its central area is monolithically enclosed.

The limitation of the cavity of the mold tool on the one hand and the positioning of the central area defined with high precision on the other hand results in an inductive component whose outer dimensions can be precisely adjusted and whose central area of the electrical conductor is determined with high precision so that the magnetic environment of the electrical conductor and in particular the central area is determined with high precision.

This allows the electrical and magnetic properties of the inductive component to be set with a high degree of accuracy, so that an inductive component with precise electrical and magnetic properties is obtained and the inductive component can be manufactured using process steps that are easy to carry out.

It is possible that the inductive component also has further first recesses in the body.

The number of recesses in the body, i.e., the possible positions or directions from which the central area of the electrical conductor can be fixed during encapsulation, determines the precision with which the central area can be set and the mechanical resistance that the central area can offer to the encapsulation compound during encapsulation.

However, the recesses in which the corresponding conductor section of the electrical conductor contains less mold material in its vicinity can be seen as inhomogeneities of the magnetic environment of the inductive component. Therefore, a certain number of recesses and certain positions for the recesses generally result for a certain inductive component, so that the advantageous properties of the recesses outweigh the absence of the corresponding material.

The depths of the recesses and the widths of the recesses are ideally selected so that the necessary mechanical stability when positioning the central area is sufficiently high and the interference with the magnetic environment is sufficiently low.

Accordingly, it is also possible for the inductive component to comprise further second recesses in the body. In this case, the first recesses and second recesses are essentially arranged on opposite sides of the inductive component.

By arranging the recesses or the corresponding ribs opposite each other in the mold tool, the central area can be optimally clamped during production so that the central area is optimally fixed during the application of the mold material.

In one embodiment, one or more or all recesses in the vertical direction y have a height h of 0.8*H≤h, where H is the height of the body. The height H of the body can be between 1 mm and 10 mm.

In one embodiment, one or more or all of the recesses have a width b of 0.1*L≤b≤0.9*L, where L is the length of the body.

In one embodiment, one or more or all of the recesses have a depth t of 0.01*L≤t≤0.5*L, where L is the length of the body.

It is possible for the recesses to have a width b of 0.1 mm≤b≤3.0 mm.

Accordingly, it is possible for the recesses to have a depth t of 0.05 mm≤t≤1.0 mm.

It is possible for the body of the inductive component to have an essentially cuboid shape. The essentially cuboid body can have edge lengths K1, K2, K3 of 0.2 mm or more and 10 mm or less.

Except for the terminals, the body can have a shape that corresponds exactly to a cuboid shape. However, it is often advantageous if the exact shape of the body deviates slightly from a cuboid shape. For example, the edges of the cuboid can each have a chamfer. Furthermore, the body can have a side surface that is asymmetrical to other side surfaces of the body in order to make it easier to orient the component, e.g. when connecting it to a printed circuit board.

It is possible that the upper side of the body has two oblique chamfers-extending in a longitudinal direction-on the transverse sides of the upper side.

It is possible that the body has one or two end faces, each with six edges.

It is possible that the body has two lateral surfaces which are opposite each other in the transverse direction x and which enclose an angle a with 0°<α≤20°.

It is possible for the first terminal and the second terminal to provide a flat surface that is accessible from the outside.

It is possible that the flat surface is suitable for making a solder connection.

Accordingly, it is possible that the inductive element is an SMD element.

For this purpose, it is possible that the terminals of the inductive component protrude from the body of the component with a certain length that is suitable for mechanically and electrically connecting the body to conductor structures on a printed circuit board. In particular, the surfaces of the terminals can be wetted with a solderable material.

It is possible that the electrical conductor has an inductance I, wherein the inductance I can be ≥5 nH and ≤470 μH.

It is possible for the inductive element to have an upper side and a lower side, with the lower side being opposite the one described above. The component can have four recesses on the upper side and two recesses on the lower side. In particular, the four recesses on the upper side can each be arranged on one side of an essentially rectangular base surface.

Accordingly, it is also preferable if the two recesses on the lower side are arranged on opposite sides of the essentially cuboid body.

It is possible for the body to have a magnetic permeability P, where the magnetic permeability P is greater than or equal to 1.5 H/m and less than or equal to 100 H/m.

It is possible that the body of the inductive component comprises a plastic, whereby the plastic is filled with a magnetic material.

In the materials for the plastic and the materials for the magnetic fillings, materials such as ferrites or iron alloys can be considered as materials for the magnetic material, which is mixed into the plastic matrix as a filler.

If the body comprises a mold material, the mold material may comprise or consist of a synthetic resin, e.g., an epoxy.

It is possible that the electrical conductor comprises or consists of a material selected from copper (Cu), silver (Ag), gold (Au) and aluminum (Al).

The recess can have an essentially rectangular, square, round, trapezoidal or oval base.

The base of the recess can contain a flat surface or consist of a flat surface.

A corresponding mold tool for manufacturing an inductive component as described above can comprise an access and a rib.

The access serves as an opening for adding the mold material during the manufacturing process. The rib serves as a support and for fixing the central area of the electrical conductor so that it is arranged with high precision in its intended position on the finished component.

It is also possible for the mold tool to have a lower part and an upper part. The lower part can have two ribs and the upper part four ribs- or vice versa. The ribs serve to hold the central area in position during the molding process and are later revealed as the recesses in the finished inductive component.

Furthermore, the mold tool can have side walls which have a cavity in which the central area of the conductor can be arranged, wherein the side walls define the later outer surfaces of the later component.

A method for centered embedding of a central area of an electrical conductor can comprise the steps:
providing a mold tool with an access and a rib,
providing the electrical conductor,
positioning the central area on the rib,
wrapping the central area by pressing a mold material through the access include.

By using the described mold tool and by applying steps of the described method, an inductive component is obtained whose central region of the electrical conductor is centered with high precision so that precisely defined material thicknesses are obtained on the side walls between the central region and the outer surfaces of the body. This results in an easy-to-produce inductive component with precisely defined electrical and magnetic properties.

### BRIEF DESCRIPTION OF THE DRAWINGS

Operating principles and details of preferred embodiments are explained in more detail with reference to the schematic figures.

FIG. 1: a perspective view of an inductive component;

FIG. 2: a perspective view of an inductive component with two chamfers on the upper side;

FIG. 3: a perspective view of the lower side of the component;

FIG. 4: a cut-away body of an inductive component so that the position and orientation of the electrical conductor can be seen;

FIG. 5: perspective view of a central area forming a coil;

FIG. 6: a perspective view of a mold tool with accesses for applying the mold material; and

FIG. 7: a cross-section through the arrangement of mold tool and mold material with size details of a preferred embodiment.

### DETAILED DESCRIPTION OF ILLUSTRATIVE EMBODIMENTS

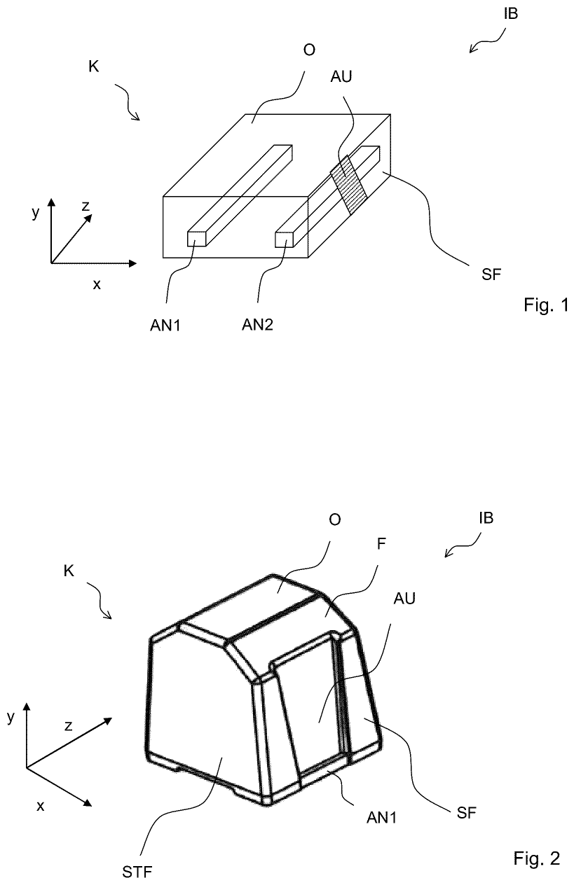

FIG. 1 shows a perspective view of an inductive component IB with a body K and a first terminal AN1 and a second terminal AN2. The body K has an essentially cuboid shape and an upper surface O. Furthermore, the body K has a side surface SF. A recess AU is arranged on or in the side surface SF. The base surface of the recess AU is tilted with respect to the vertical direction y or with respect to the side surface SF, so that relative thereto a rib R of a mold tool can exert a force component downwards (-y-direction) and can fix the central region of the electrical conductor relative to a base and relative to a mold material. In the perspective view, it can be seen that the terminals AN1, AN2 are arranged on the lower side. These can be provided for SMD mounting, for example.

FIG. 2 shows a perspective view of the inductive component OB with the body K. The essentially cuboid body K has two chamfers F on its edges on the upper side O. These oblique surfaces reduce burrs and can simplify further assembly.

The recess has an essentially trapezoidal base, with the edge on the upper side being longer than the edge on the lower side.

In particular, the recess is shaped in such a way that a rib (possibly better referred to as a lamella or stamp, depending on the width) of a mold tool is in direct contact with at least part of the top of the first terminal AN1. As a result, this can be pressed even better with a force onto a base of the mold tool in order to fix the terminal and the central area.

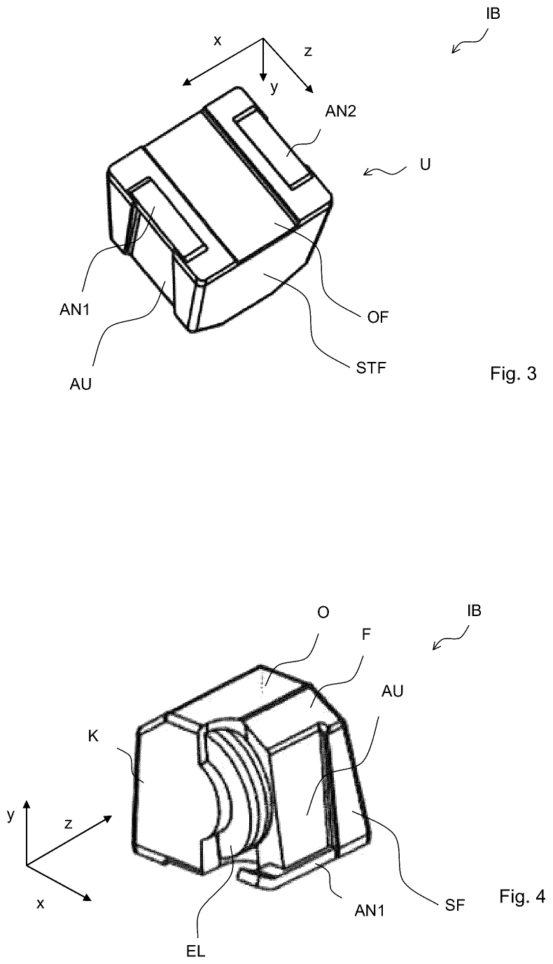

FIG. 3 shows a perspective view of the inductive component IB with the lower side U facing the observer. It can also be seen that the essentially cuboid body K has an orientation surface OF instead of an edge, which simplifies the orientation and alignment of the component IB due to the symmetry breaking.

FIG. 4 shows a perspective view of an inductive component IB with a section through the body K, so that the position of the electrical conductor inside the body K is recognizable.

FIG. 5 shows a perspective view of the electrical conductor EL, in which the central area ZB contains windings of a coil that are electrically connected in series between the first terminal AN1 and the second terminal AN2. The terminals AN1, AN2 are used to connect the inductive component to an external circuit environment. The shape of the conductor EL in the central area ZB essentially determines the electrical and magnetic properties of the inductive component.

The electrical conductor itself is formed from a strip with a width and a thickness, whereby the thickness is smaller than the width.

The windings of the coil are insulated from each other by the dielectric material of the body K.

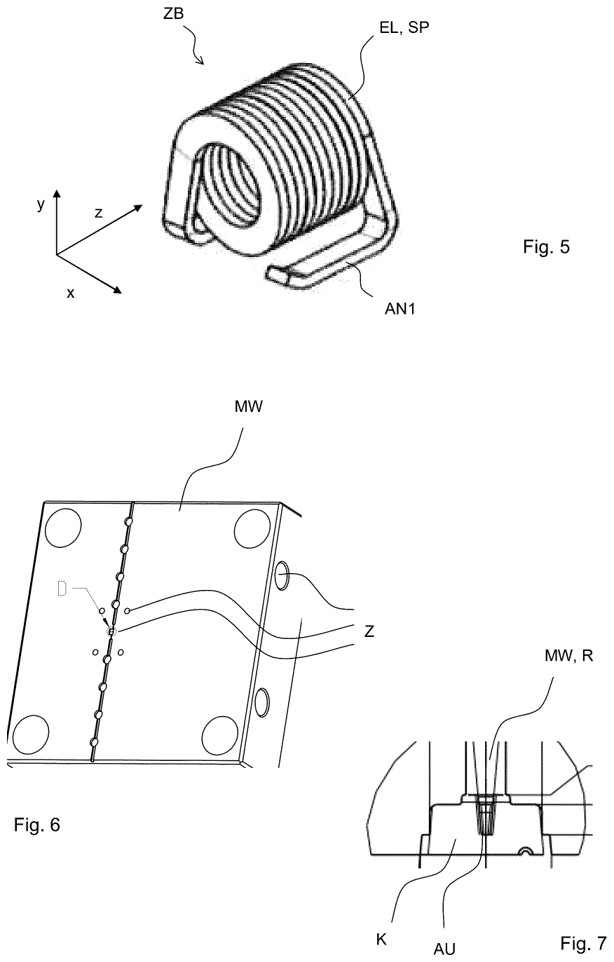

FIG. 6 shows a perspective view of a mold tool MW that has accesses Z that are designed as holes. The casting compound can be pressed into the cavity behind it with an appropriate pressure via the openings Z so that the cavity is completely filled without the central area of the electrical conductor being pushed away from its preferred position.

FIG. 7 shows a cross-section and the presence of the rib R during molding, which holds the central area in place and at whose position the later recess will be positioned, since the mold compound cannot occupy the volume of the rib R.

1-28. (canceled)

29. An inductive component comprising:
an electrical conductor with a first terminal, a second terminal and a central region, which is electrically arranged between the first terminal and the second terminal; and
a body comprising a central area,
wherein the central area is centered in the body, and
wherein the body has one or more first, outwardly open recess(es).

30. The inductive component according to claim 29, wherein each of the one or more recesses encloses an angle β with a respective side surface with 0°≤β≤20°.

31. The inductive component according to claim 29, wherein the conductor in the central region is formed into one or more coil(s).

32. The inductive component according to claim 29, wherein the body comprises a mold material or consists of a mold material.

33. The inductive component according to claim 29, wherein the central region is embedded in the body.

34. The inductive component according to claim 29, wherein the body comprises one or more second, outwardly open recess(es) arranged opposite the first recesses on the body such that the central region is arranged between the first and second recesses.

35. The inductive component according to claim 29, further comprising further first recesses in the body.

36. The inductive component according to claim 29, further comprising further second recesses in the body, wherein first and second recesses are arranged on opposite sides of the body, respectively.

37. The inductive component according to claim 29, wherein one or more or all recesses have a height h in a vertical direction y with 0.8*H≤h, wherein H is a height of the body.

38. The inductive component according to claim 29, wherein one or more or all recesses have a width b of 0.1*L≤b≤0.9*L, wherein L is a length of the body.

39. The inductive component according to claim 29, wherein one or more or all recesses have a depth t with 0.01*L≤t≤0.5*L, wherein L is a length of the body.

40. The inductive component according to claim 29, wherein the first recesses have a width b of 0.1 mm≤b≤3.0 mm.

41. The inductive component according to claim 29, wherein the first recesses have a depth t of 0.05 mm≤t≤3.0 mm.

42. The inductive component according to claim 29, wherein the body has a substantially cuboidal shape with edge lengths K1, K2, K3 with 0.2 mm≤K1, K2, K3≤10 mm.

43. The inductive component according to claim 29, wherein the body has, at an upper side, two oblique chamfers extending in a longitudinal direction at transverse sides of the upper side.

44. The inductive component according to claim 29, wherein the body has one or two end faces each having six edges.

45. The inductive component according to claim 29, wherein the body has two side faces, which are opposite each other in a transverse direction and which enclose an angle a with 0°<α≤20°.

46. The inductive component according to claim 29, wherein the first terminal and the second terminal provide an externally accessible flat surface.

47. The inductive component according to claim 46, wherein the flat surface is configured for a solder connection.

48. The inductive component according to claim 29, wherein the inductive component is an SMD element.

49. The inductive component according to claim 29, wherein the electrical conductor has an inductance I and 5 nH≤I≤470 μH.

50. The inductive component according to claim 29, wherein the inductive component has an upper side and an opposite lower side and 1, 2, 3 or 4 recesses on the upper side and 1, 2, 3 or 4 recesses on the lower side.

51. The inductive component according to claim 29, wherein the body has a magnetic permeability P of 1.5 H/m≤P≤100 H/m.

52. The inductive component according to claim 29, wherein the body comprises a plastic filled with a magnetic material.

53. The inductive component according to claim 29, wherein the electrical conductor comprises or consists of Cu, Ag, Au, or Al.

54. The inductive component according to claim 29,
wherein two recesses are arranged opposite each other,
wherein one of the two recesses is arranged on a side surface of the body and the other of the two recesses is arranged on an opposite side surface of the body,
wherein each recess is inclined to its respective side surface,
wherein the two recesses form a v-shape and a distance between the two recesses increases in a direction towards the first and the second terminal,
wherein the two recesses have a height h in a vertical direction y with 0.8*H≤h,
wherein H is the height of the body, and
wherein the vertical direction is perpendicular to a lower side of the component on which the first and the second terminal are provided.

55. A mold tool for manufacturing the inductive component according to claim 29, wherein the mold tool comprises an access and a rib.

56. The mold tool according to claim 55, further comprising a lower part, an upper part, 1, 2, 3 or 4 ribs on the lower part and 1, 2, 3 or 4 ribs on the upper part.

57. A method for embedding a central portion of an electrical conductor, the method comprising:
providing a mold tool with an access and a rib;
providing the electrical conductor;
positioning a central area on the rib; and
wrapping the central area by pressing a mold material through the access.
